(19) United States
(12) Patent Application Publication
(10) Pub. No.: US 2020/0037009 A1
(43) Pub. Date: Jan. 30, 2020

(54) SYSTEM DEVICE AND METHODS FOR PRESENTING MEDIA CONTENTS

(71) Applicant: BLINK APP LTD., Jerusalem (IL)

(72) Inventors: Yair SHAPIRA, Nehusha (IL); SHAI BARASHI, Motza Ilit (IL); PAVEL WEINSTOCK, Givataim (IL); DAVID BRAGINSKY, Jerusalem (IL); MOSHE SHLISSEL, Jerusalem (IL); GAVIN HOWARD GOODVACH, Jerusalem (IL); JOSIAH MEYER ROTENBERG, Jerusalem (IL)

(21) Appl. No.: 16/076,428

(22) PCT Filed: Jan. 28, 2018
(86) PCT No.: PCT/IL2018/050095

§ 371 Date: Aug. 8, 2018

Related U.S. Application Data
(60) Provisional application No. 62/559,563, filed on Sep. 17, 2017.
(60) Provisional application No. 62/559,560, filed on Sep. 17, 2017.
(60) Provisional application No. 62/549,438, filed on Aug. 24, 2017.

(51) Int. Cl. H04N 21/234; G06K 9/00; H04N 21/472; H04N 21/237; H04N 21/266; H04N 21/2343; H04N 21/258

(52) U.S. Cl. CPC H04N 21/23418; G06K 9/00765; G06K 9/00744; G06K 9/00718; G06F 3/04817; H04N 21/237; H04N 21/26603; H04N 21/234336; H04N 21/25891; H04N 21/47202

(57) ABSTRACT

A device comprising a user interface configured to receive a navigation command from a user and a communication module configured to communicate with a server, the server comprising: a segmentation module configured to download one or more media contents from one or more external sources and divide the downloaded media contents into a plurality of media segments based on semantic analysis; a semantic segment management module configured to analyze each media segment of said plurality of media segments to yield a plurality of related media segments; a processor configured to: receive from said server said plurality of media segments; present on said display one or more media segments of said plurality of media segments and in response to said navigation command present the most related segment of said plurality of related media segments on said display.

### CROSS-REFERENCE

The present application claims the benefit of U.S. Provisional Application Ser. No. 62/549,438, filed on Aug. 24, 2017, entitled “System Device and Methods for Presenting Media Contents” and U.S. Provisional Application Ser. No. 62/559,560 filed on Sep. 17, 2017, entitled “Automatic Chapter Detection by Structure”, and U.S. Provisional Application Ser. No. 62/559,563, filed on Sep. 17, 2017, entitled “Push and Swipe”, each of which is incorporated herein by reference in its entirety.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### FIELD OF THE INVENTION

The present invention relates to streaming media, and in particular to systems, devices and methods for presenting media contents such as long form media contents.

### BACKGROUND OF THE INVENTION

Media content consumption is changing incessantly. Traditional viewing habits were generally passive. For example, following a TV channel or content selection, consumers viewed the content until its completion. Over time, the number of channels has increased and the consumers have become more active. In many cases, consumer starts viewing a particular content and then at some point decides to navigate to another channel. This has become much more popular and frequent with viewing content from the Internet, where viewers are used to navigate between different content sources. In addition, while viewing content from the Internet, especially with mobile devices, viewers have become accustomed to watching snippets of a program rather than the whole program and rapidly switching to another snippet. Therefore, there is a need, to help users locate and switch to the most interesting content.

Various methods and systems for presenting media contents, such as television programs (e.g. sports, news etc.), music or video clips on social mobile video platforms or live-streaming options on online video platforms, and linking between media contents are known in the art. For example, U.S. Pat. No. 8,650,596 entitled “Multi-axis television navigation” whose disclosure is incorporated herein by reference, describes an exemplary multi-axis television navigation system which defines television navigation axes according to attributes of television programs. In one implementation, if a television program has an attribute defining an axis, then the exemplary system links a predefined database query associated with the axis to metadata for the television program. When launched, the predefined query returns a sequence of navigable television programs having the attribute that defines the axis.

Another example for multi-axis user interface for navigation applications is disclosed in U.S. Patent Application Publication number 2013/0254705, entitled “Multi-axis user interface for a touch-screen enabled wearable device” whose disclosure is incorporated herein by reference, provides a multi-axis user interface for a touch-screen enabled wearable device. The multi-axis user interface comprises at least two user interface regions displayed on the touchscreen one at a time, each displaying a series of one or more application screens; and a combination of a vertical navigation axis and a horizontal navigation axis, wherein the vertical navigation axis enables a user to navigate between the multiple user interface regions in response to vertical swipe gestures made on the touchscreen, and the horizontal navigation axis enables the user to navigate the application screens of a currently displayed user interface region in response to horizontal swipe gestures across the touchscreen.

### SUMMARY OF THE INVENTION

The present disclosure provides a system, device and methods for presenting media contents and segmenting the media contents to a number of media segments. The device may comprise a display; a user interface configured to receive a navigation command from a user, a communication module configured to communicate with a server, the server comprising: a segmentation module configured to download one or more media contents from one or more external sources and divide the downloaded media contents into a plurality of media segments based on semantic analysis; a semantic segment management module configured to analyze each media segment of the plurality of media segments to yield a plurality of related media segments; a processor configured to: receive from the server the plurality of media segments; present on the display one or more media segments of the plurality of media segments and in response to the navigation command present the most related segment of the plurality of related media segments on the display.

In many embodiments, the segmentation module is configured to analyze the one or more downloaded media contents and define a segment structure for each of the plurality of media segments.

In many embodiments, the segment structure is defined according to attributes or features of each of the plurality of media segments.

In many embodiments, the attributes are selected from the group consisting of: well defined set of images; anchor images; camera angel or focus; audio energy or frequencies.

In many embodiments, the semantic segment management module is configured to analyze attributes or features of the plurality of media segments to yield semantic info.

In many embodiments, the sematic info comprises formal naming of attributes or features.

In many embodiments the formal naming of attributes and features are topics or names of persons.

In many embodiments, the semantic segment management module is configured to generate a media segment object for each media segment of the plurality of media segments.

In many embodiments, the media segment object comprises: segment's borders; segment semantic data info; links between segments of similar semantics.

In many embodiments, the semantic data info comprises common meaning of features and attributes of the media content.

In many embodiments, the semantic analysis comprises measuring a semantic similarity between media segments of the plurality of media segments and interlinking the media segments.

In many embodiments, the semantic similarity between segments is measured according to topic or chronological order or media segment rating or contextual relation between media segments.

In many embodiments, the semantic segment management module is configured to convert the downloaded media contents to text for segmenting the converted media content to a plurality of media segments.

In many embodiments, the downloaded media content is segmented using machine learning techniques.

In many embodiments, the downloaded media content is segmented according to identified keywords or named entities on a text of the media content.

In many embodiments, the related media segments are of different media segments.

In many embodiments, the related media segments are of the same media segments.

In many embodiments, the navigation command is in the form of one or more gestures or swipes.

In many embodiments, the navigation command is selected from a group of navigation commands consisting of: horizontal left gesture; horizontal right gesture; vertical left gesture; vertical down gesture; vertical up and left gesture; vertical up and right gesture; vertical down and left gesture; vertical down and right gesture, push and swipe gesture.

In many embodiments, wherein the user interface is configured to present one or more icons, the icons comprise links to recently viewed segments.

In many embodiments, the icons comprise one or more images of the viewed media segments.

In many embodiments, the related segments are identified according to the user navigation history.

In many embodiments, the related segments are identified according to the user previous “push and swipe” gestures.

In many embodiments, the device may comprise a video talk back application.

In many embodiments, the related segments are one or more user video recorded feedbacks of a media segment.

In many embodiments, the most related media segment is selected by cross evaluating one or more of the following lists: list of related segments of currently viewed segments; list of attributes based on viewer interest; list of attributes of viewed segments of the current play session; images selected by the viewer by ‘push and swipe’ action.

In many embodiments, a plurality of related feedbacks may be linked to one or more media segments of the plurality of media segments.

In many embodiments, each related feedback segment comprises a weight which may be defined according to the importance or relevance of the related feedback segment.

In many embodiments, the device comprises one or more short cut navigations buttons for navigating back from one of the plurality of media segment to the first or previously viewed media segment.

In accordance with a second aspect of the invention there is provided a method for navigating between a plurality of media segments of one or more media contents, the method comprising: displaying a media content on a display of a device having a processor; activating a segmentation module configured to divide the downloaded media content into a plurality of media segments and a semantic segment management module configured analyze each media segment of the plurality of media segments to yield a plurality of related media segments; processing the navigation command at the processor, displaying related media segments according to the processed navigation command.

In many embodiments, the navigation command is a vertical navigation request and in response to the vertical navigation request the server checks if the vertical navigation request is vertical up navigation request or vertical down navigation request and if the user navigation request is a vertical up navigation request the server evaluates the most related segment for the currently viewed segment, if not, then the server reads the previous viewed related segment.

In many embodiments, the navigation command is a horizontal navigation command and the server reads from the segment media object the next segment of the program.

In accordance with a third aspect of the invention there is provide a method comprising: downloading at least one media content from a server or any content source; analyzing the at least one media content to identify a plurality of media segments at the at least one media content based on semantic analysis; evaluating attributes or features for each of the plurality of media segments to yield semantic information for each media segment; linking media segments which have semantic similarity; displaying a media segment to a user; in response to a user navigation command presenting a most related media segment which is linked with the displayed media segment.

In many embodiments, the method comprising selecting the most related media segment by cross evaluating one or more of the following lists: list of related segments of currently viewed segments; list of attributes based on viewer interest; list of attributes of viewed segments of the current play session; images selected by the viewer by ‘push and swipe’ action.

In accordance with a forth aspect of the invention there is provided a communication module configured to communicate with a server, the server comprising: a segmentation module configured to download one or more media contents from one or more external sources and divide the downloaded media contents into a plurality of media segments based on based on semantic analysis; a semantic segment management module configured to search one or more semantic similarities between the plurality of media segments to yield a plurality of related media segments; a processor configured to: receive from the server the plurality of media segments; present on the display one or more media segments of the plurality of media segments and in response to the navigation command present the most related segment of the plurality of related media segments on the display.

### BRIEF DESCRIPTION OF THE DRAWINGS

A better understanding of the features and advantages of the present disclosure will be obtained by reference to the following detailed description that sets forth illustrative embodiments, in which the principles of embodiments of the present disclosure are utilized, and the accompanying drawings.

FIG. 1A shows a schematic diagram of a client server system for navigating between related media se

FIG. 1B shows a schematic block diagrams of a structure of exemplary two media contents, in accordance with embodiments.

FIG. 2 shows a schematic representation of user interface video screens, in accordance with embodiments;

FIG. 3 illustrates a flowchart of a method for evaluating the related segments in accordance with embodiments; and

FIG. 4 illustrates a flowchart of a method for building viewer interest profile;

FIG. 5 illustrates a flowchart of a method for navigating between media segments, in accordance with embodiments; and

FIG. 6 illustrates a flowchart of a method for evaluating the most related segments from a list of related segments in accordance with embodiments.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of the claims.

Prior to the detailed specification of the invention being set forth it may be helpful to set forth definitions of certain terms that will be used hereinafter.

As used herein like characters refer to like elements.

The term ‘media segment’ as used herein and through the specification and claims should be understood to encompass a portion of media content which is semantically characterized. For example, a goal in a football game may be defined as a media segment. In some cases, the media segment borders may be defined by timing information, typically at the beginning and end of the segment.

The term ‘related segment’ as used herein and through the specification and claims should be understood to encompass a segment which has semantic similarity for example, based on the likeness of meanings or semantic content with another media segment.

The term ‘most related segment’ as used herein and through the specification and claims should be understood to encompass a media segment which is selected to be the most related to another media segment from a plurality of potential related segments.

The term ‘semantic relation’ as used herein and through the specification and claims should be understood to encompass a relationship between two or more segments based on common meaning of the segments.

As used herein “media content” encompasses program or media programs or video programs.

In accordance with a first embodiment there are provided devices, systems and methods for segmenting, for example automatically, one or more media contents to a number of media segments and presenting the media segments content.

In accordance with a second embodiment there are provided devices, systems and methods for automatically segmenting a media content to a plurality of media segments according to the media content type and/or structure.

In some embodiments, the segmentation may be operated automatically and/or in real time. For example, ‘live’ programs such as news or sports may be segmented automatically in real-time while the viewer is viewing the program. In some cases, the segmentation process may be completed once the program ends or prior to the completion of the program.

In accordance with a third embodiment, there are provided devices, systems and methods for navigating between media segments and related media segments. The navigation may be between segments of the same media content as well as navigating between related segments of different media contents.

According to a forth embodiment there is provided an improved content viewing experience method and system comprising providing media segments that are interlinked to enable a viewer to easily and associatively navigate from one media segment to another media segment. In some embodiments, the viewer may navigate associatively or according to automatically displayed media segments of one media segment to other media segment in a media content which is related, for example by topic or other category, to the viewed media segment.

A specific example of an improved multi-dimensional content viewing experience method and system, in accordance with embodiments, may relate to daily news viewing. Typically, each online or offline news program includes a number of different topics such as politics, economics or weather. In respect to a particular news program (e.g. media segment) for example in economics, the user views a program about a very successful company which manufactures an innovative product. If the user is interested in viewing more programs related to the viewed company or the innovative product, he may initiate a navigation command, for example in the form of a vertical navigation gesture. As a result, the system may automatically pause the current news program, and present to the user another program (e.g. a second viewing dimension) related to the viewed company or the innovative product (e.g. related segment) such as a documentary film on the company. While viewing the documentary film the user may navigate backward and forward between segments in the documentary film by for example, a horizontal navigation gesture. Moreover, if while viewing a media segment in the documentary film which includes information on a private equity that invests on the company, the user is interested in viewing more programs related to the private equity (e.g. third dimension), he may initiate another navigation command such as a vertical navigation gesture, and accordingly the system may automatically pause the viewed program and present to the user one or more media segments of another news program which includes more details on the investments of the private equity.

In another embodiment, the system and method comprises evaluating a plurality of media segments, searching one or more semantic similarities between the media segments and interlinking the related segments. For example, a single media segment such as a football goal may be related to more than one media segment, such as the football player (e.g. first related segment) and the football team (e.g. second related segment).

In another embodiment, the system may comprise a user profile information module which may include for example a viewer interest profile. The viewer interest profile may contain information related to the user's general or specific interests which may be based for example on the user's favorite media viewing habits. In some cases, the viewer interest profile will determine which related segments will be presented to the user.

In another embodiment, the system is configured to track and/or upload the user's navigation history to determine which related media segment will be presented to the user. The user's navigation history may include for example, viewed segments and/or the user's latest played navigation session(s).

In another embodiment, the user may indicate and specify his interest on a related segment by using for example a “push and swipe” gesture. For example, while watching a media segment the viewer wishes to view more media contents relating to the viewed media content (e.g. related segments) the viewer may indicate his interest for viewing the related segment by pushing and selecting an image of interest in a video frame of a currently viewed segment. In some cases the “push and swipe” selection gesture or posture may be operated using navigation tools such as a mouse or joystick or by physically pointing on a touch screen.

In another embodiment, the system is configured to identify related segments according to one or more of the following: a segments' semantic similarity, user profile, user navigation history, previous “push and swipe” gestures or combination therein.

In some cases, the user may preform one or more ‘navigation commands’ for navigating from one media segment to another segment. The navigation commands may include simple and consistent postures or gestures such as swipes. For example a horizontal gesture means moving between segments of the same program while a vertical gesture means navigating to a related segment of a different program.

In another embodiment, the system and method may support a video talk back application and the related segment may be defined as a user video recorded feedback of a media segment. For example, a first user may upload a video recording comprising a feedback related to a particular media segment. A second user viewing the particular media segment may navigate to the first user video feedback by performing a navigation command (e.g. vertical gesture). The second user may upload a video recording compromising his feedback related to the particular media segment or a feedback related to the first user's video feedback. Accordingly, another viewer (e.g. a third viewer) may upload a recorded feedback to new media segments and/or pervious media segments and/or previous video feedbacks

In some embodiments, a plurality of related feedbacks may be linked to one or more related segments and the system may present to the user the related feedback upon user's navigation commands.

In some embodiments, a related feedback segment may be defined according to a semantic significance of the related feedback segment, e.g. each related feedback segment comprises a weight which may be defined according to the importance and/or relevance of the related feedback segment as may be defined the user or the system. For example feedback of celebrities will gain higher weight than ordinary people.

In some embodiments, the system is configured to present viewed media segments such as media segments recently viewed by the user. For example, following the user's navigation commands which included for example viewing a number of media segments related to different media contents, the user may navigate back to previous viewed media segments.

In some embodiments, the system is configured to present one or more icons which may include links to recently viewed segments. Each icon may include one or more images of the viewed segments, for example the latest viewed image of the segment. In operation, an ‘icon window’ is presented to the user for selecting the icon which represent the segment which the user would like to navigate back.

In some embodiments, the system may include one or more ‘short cut’ navigations buttons for directly and swiftly navigating back from any media segment to the first or previously viewed media segment, e.g. the segment viewed before any navigation command was performed.

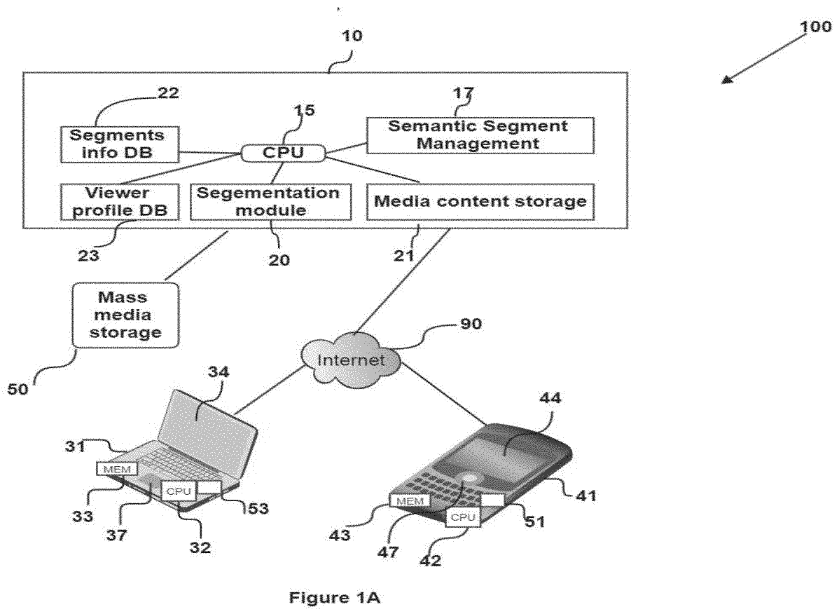

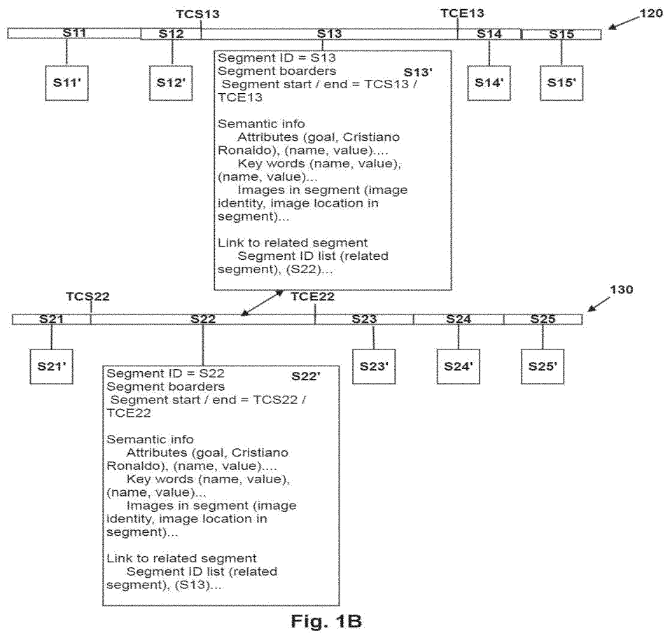

FIG. 1A shows a schematic diagram of a system 100, such as a client server system, for providing multi-dimensional viewing experience, in accordance with embodiments. The system 100 includes a media server 10 comprising one or more processors such as CPU (Central Processing Unit) 15. The CPU 15 is configured to operate one or more modules, for example, a segmentation module 20 and a semantic segment management module 17. The segmentation module 20 is configured to constantly download media contents from one or more external sources such as Internet mass media storages 50, and divide the downloaded contents into media segments based on semantic analysis. In some cases, the download may be performed automatically and/or simultaneously. The semantic segment management module 17 is configured to manage and analyze one or more semantic data for each media segment and the semantic relation between media segments. Additionally, the semantic segment management module 17 is configured to generate for each media segment one or more media segment objects for storing segment information including for example segment semantic data info and links between segments of similar semantics, as will be further illustrated herein in respect to FIG. 1B. The semantic data info of each media object may comprise common meaning of features and attributes of the media content used to characterize the media content.

In operation, the semantic segment management module 17 analyzes the common features and attributes of one or more or every media segment, and defines the semantic characteristic of each media segment. For example, for a downloaded news program, the semantic segment management module 17 defines one or more features and attributes for each media segment in the downloaded news program such as the topic or description of a main event presented at the news, a specific title within the media segment, personality such as a specific person which the news is about or a commentator expert discussing a specific subject on the news. Additionally, the semantic segment management module 17 is configured to measure the semantic similarity between segments and link between segments which relate to one another based on for example the semantic similarity. For example, the semantic similarity between segments and/or the order between related segments, may be measured and evaluated according to topic, chronological order, media segment rating, contextual relation between media segments.

The media server 10 further comprises one or more storage units, such as storage units 21, 22 and memory unit 23. One or more of the storage units such as storage unit 21 may comprise the media contents or URL to the stored content stored for example in another network server. In some cases, one of the storage units, such as storage unit 22 may comprise information relating to media segments of the media contents stored in storage unit 21. Specifically, the stored information includes for example the media segment objects of the media segments.

In some cases, the memory unit 23 may store a viewer's profile information. The viewer's profile information may include for example the user's profile semantic info features and attributes of semantic content associated with the particular viewer. For example, the viewer profile semantic info may include general or specific viewer's interest in respect to viewed program.

The system 100 further comprises one or more client devices 31 and 41 which may be in communication via the server network 90 with CPU 15.

The devices 31 and 41 may comprise, for example, desktop, laptop, or tablet computers, media consoles, personal digital assistants or smart phones, or any other sort of device with the types of network, video and audio interfaces and computing capabilities needed to interact with the server 10. By way of example, device 31 comprises a computer with a processor 32, memory 33, display 34, a user interface configured to receive a navigation command from a user, a communication module configured to communicate with the server 10 and other units such as speakers. Device 41 may be similarly equipped, though in different configurations. For example device 41 may be a mobile phone comprising a processor 42, display 44 and memory 43.

The processors 32 and 42 comprise a media player module which is configured to download one or more media contents, for example from the server network 90. The devices 41 and 31 may further comprise sensing units 47 and 37 which are configured to receive and recognize the user's navigation commands. For example the sensing units 47 and 37 may be a touchscreen or a sensor such as a gesture recognition sensor configured to identify one or more navigation commands for example play a requested media segment or skip to the next content segment. The navigation commands may include for example one or more swipes across the touchscreen. Alternatively, the navigation commands may be one or more gestures or postures. The gestures can originate from any bodily motion such as the face or hand.

The swipe or gesture commands may be transmitted via the network 90 to the server 10, and accordingly the server 10 responds with the next media segment to be played or with an URL for the next segment. For example, swiping the screen from right to left while viewing a current segment of a program will display the next segment of the media content, while swiping up or down may allow the user to scroll through related media segments of other media contents.

According to some embodiments, the devices 31 and 41 may comprise respectively recording modules 51 and 53 for tracking and recording the user's navigation history. In some cases, the navigation history and viewed segments may be stored according to FIFO (first in first out) methods.

FIG. 1B shows schematic block diagrams of a structure of exemplary two media contents 120 and 130, in accordance with embodiments. Each of the media contents 120 and 130 is divided into a plurality of media segments. For example, media content 120 is divided into five media segments S11, S12, S13, S14, S15 and media content 130 is divided into five media segments S21, S22, S23, S24 and S25. According to some embodiments, each media segment includes a corresponding media segment object, for example respective media segment objects S11′, S12′, S13′, S14′, S15′ of media content 120 and respective media segment objects S21′, S22′, S23′, S24′ and S25′ of media content 130.

According to some embodiments, each media segment object includes information on the respective media segment. The information includes for example the media segments: ID number; borders (e.g. segment start and segment end); semantic information; and links to one or more related segments. In some cases, the semantic information comprises one or more attributes relating to the media segment and/or key words and/or images of the segment.

Specifically, the media segment object information S13′ comprises for example the following information:

### Segment ID=S13

Segment boarders:
segment start: TCS 13/segment end: TCE 13
semantic info:
attributes: (goal, Cristiano Ronaldo),(name, value) . . .
Key words: (name, value), (name, value) . . .
Images:(image identity, image location in segment) . . .
Link to related segment: Segment ID list: (related segment), (S22) . . .

In the example illustrated in FIG. 1A media segments S22 and S13 are related segments, accordingly the media segments are interlinked and the media segments object info S22′ and S13′ include links to each respective media segment.

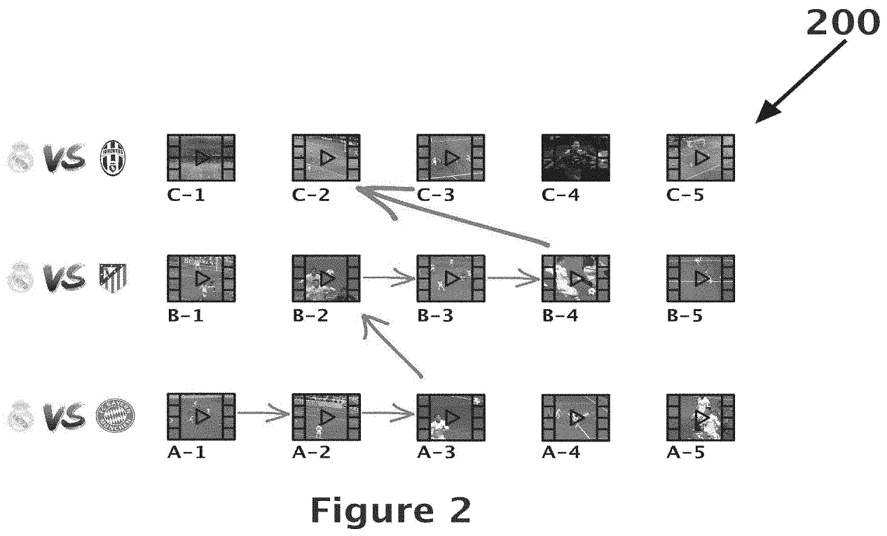

FIG. 2 shows a schematic representation of a user interface screen structure 200, in accordance with some embodiments. The user interface 200 may include for example video screens A1-A5, B1-B5, C1-C5 presenting one or more video programs such as sport programs which may be displayed for example on a user device display. Specifically, according to some embodiments, the devices, systems and methods are configured to provide multi-dimensional viewing experience, by displaying two or more programs, for example three exemplary programs A, B and C according to the viewer navigation action as described in further detail herein. The three programs A-C include three different football match programs of three different football match games: program A includes a match between Real Madrid and Bayern Mfinchen, program B includes a match between Real Madrid and Atletico Madrid and program C includes a match between Real Madrid and Juventus. In accordance with embodiments, each of the three programs A, B and C are accordingly divided into media segments A1-A5, B1-B5 and C1-C5. According to one embodiment, while viewing segment A3, as the user was very impressed with Cristiano Ronaldo goal, the user initiates a navigation command, for example a vertical navigation gesture which indicates he wishes to view another media segment which is related to the viewed media segment (e.g. A3). The user or the system may automatically or manually pause segment A3 and the system may automatically present to the user a related segment B2 of program B, which includes another program segment of Cristiano Ronaldo goal. The user may proceed viewing segment B3, and for example while viewing B3, may operate another horizontal navigation requests indicating that he would like to skip to the next segment in the same program B. As a result the system will pause segment B3 and will automatically present segment B4.

While viewing segment B4, as the user was very excited with Cristiano Ronaldo missing a wonderful opportunity for a goal, the user may perform another navigation action, such as a vertical up navigation command indicating that he would like to view another media segment related to the viewed media segment. Accordingly, the system may pause segment B4 and will automatically present related segment C2 of program C, which includes another video of Cristiano Ronaldo missing a wonderful opportunity for a goal.

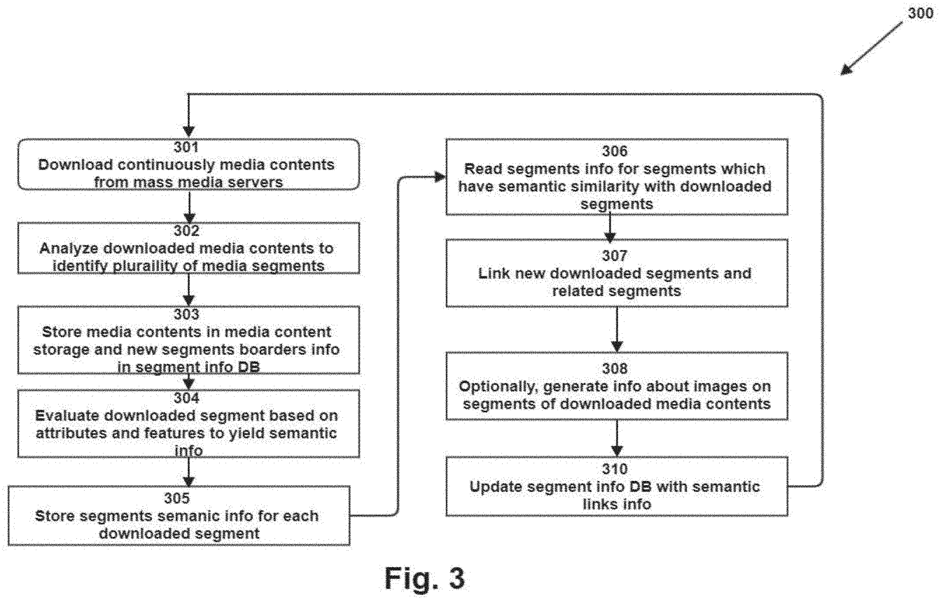

FIG. 3 shows a flowchart of a method 300 for analyzing media segments such as related media segments, operated for example by the segmentation module 20 and the semantic segment management module 17, in accordance with embodiments. At step 301, media contents such as media programs are downloaded, for example continuously, from one or more media servers such as mass media storages 50. For example, the media content may be or may include News or Sports programs. The News or Sports programs can be live or near to live or a recorded program. In some cases, the media contents are downloaded by the segmentation module 20. At step 302, the downloaded media content is analyzed, for example by the segmentation module 20, to identify a plurality of media segments based on semantic analysis. The semantic analysis may include measuring a semantic similarity between media segments and interlinking the media segments. In some cases, the semantic similarity between segments is measured according to topic or chronological order or media segment rating or contextual relation between media segments. For example, different topics in a news program, related to different issues such as sports and fashion will be classified as a number of well-defined separated semantic units. In some embodiments, a segment structure is defined for each media content type, for example by the segmentation module 20. In some embodiments, the segment structure is defined according to attributes or features characterizing the segment boarders or media segments. Such attributes or features can be particular well defined set of images comprising a specific graphic display or structure in certain places of the screen, anchor images, camera angel and/or focus, including analyzing of audio energy and/or frequencies. In another embodiment, known in the machine learning art, techniques may be applied on the downloaded media content to identify semantic units in every program. For example, the downloaded media contents may be converted to text by speech-to-text methods and then segmented for example by machine learning techniques according to identified keywords, named entities on the text or other findings included in the converted media content. At step 303, the segmented media contents are stored, for example at the media content storage 21, or at other storage units. In addition, a plurality of borders related to the plurality of media segments may be stored, for example at the Segments info DB info 22. At step 304 one or more attributes and/or features are evaluated or analyzed for each media segment, for example by the semantic segment management module 17, to yield semantic info, for example for each media segment.

The segment semantic info may comprise a formal naming of attributes and features, e.g. topics, names of persons etc. to enable accurate semantic relation evaluation between segments. In some cases, the segment semantic info format may depend on the media content type, thus providing an accurate formal naming for the particular content type.

In one embodiment, the attributes and features are defined according to the genre or topics of the media content.

In some cases, the evaluation process may include a conversion step which may be performed by convertors engines as known in the art, such as speech to text converters followed by an analysis step performed by for example a processor (e.g. CPU 15). In another embodiment, the evaluation process may be performed using a textual screen version of the media content. In another embodiment, the evaluation process may include utilizing advanced semantic video processing algorithms, such as topic modelling configured to map attribute features of the semantic segment. In another embodiment, semantic info may be defined manually.

In some cases, the resulted segment semantic info of the semantic evaluation process of each segment, (e.g. the segment semantic info) may be stored at the segment media object.

At step 305, the segment semantic info for some or all or substantially all segments of the downloaded media content are stored, for example by the semantic segment management module 17 on the DB of segment info memory unit 22.

At the next steps, the relation between the pluralities of media segments is determined. In some embodiments, the related segments for each media segment includes many segments. For example, a goal in a football game may relate to a goal of the same game player or to another goal between the same two groups, so each related segment may be ranked according to the semantic similarity. For example the most related segment may be ranked ‘10’ and the least may be ranked ‘0’. The media segment object of each segment is updated with the list of related segment with attributes information that defines how segments are related, for example the same game player, the same group etc.

At step 306, for each media segment of the downloaded media content, the semantic segment management module 17 downloads, for example from memory unit 22, the segment's media objects of segments which have semantic similarity with the downloaded segment. At step 307, the semantic segment management module 17 links new downloaded segments and previous downloaded related segments. Optionally at step 308, for each new downloaded media content, a search is performed, for example by the server, for one or more images which were included in the downloaded media segment. Based on the identified images a list of images is provided comprising images which are related to each downloaded segment. The list may include information about the image identity and its location in the segment. At step 310 the server updates the segment media objects of each segment with the semantic links.

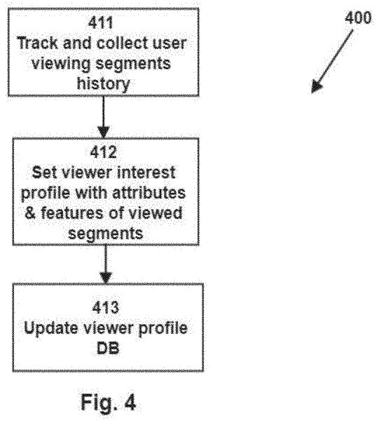

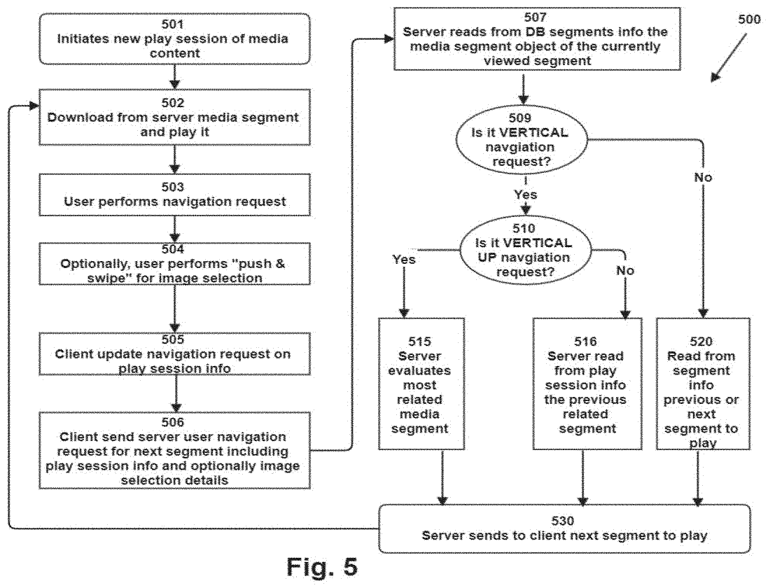

FIG. 4 shows a flowchart of a method 400 for building, for example continuously, the viewer DB profile 23 based on the viewer's viewing history, operated for example by the semantic segment management module 17, in accordance with embodiments. At step 411, the server or other unit tracks and collects the user's viewing segments history (e.g. segments viewed by the viewer). At step 412, for each viewed segment, the server reads from the media segment object's info stored in the DB of segment info unit 22 and set viewer interest profile with attributes and features of viewed segments. The segment semantic info may include attributes and features as illustrated herein above in respect to FIGS. 1A and 3. At step 413, the server updates the viewer profile DB 23. FIG. 5 is a flow chart illustrating a method 500 for navigating between media segments in accordance with embodiments. The method 500 may be performed by a server, such as server engine 10 shown in FIG. 1. At step 501, for example upon user request, a new media content play session is initiated, for example by the media player of processor 32. In some cases, once a media content is downloaded, the media player initiates a playing session info module which records the user's navigation requests and viewed segments. At step 502, the media player module downloads the next media segment and plays it for example on the user's display. The downloaded next media segment may be the first segment of the media content which will be displayed once the user starts a new play session or the next segment to be played following a previous navigation request. It should be noted that, in some cases, for performance reasons, as the media player software module downloads from the server the next media segment, it may additionally download a number of media segments. For example, the media player buffers a plurality of media segments on memory 43.

At step 503, the user performs a navigation request which is received and processed for example by the media player module. For example, while viewing the downloaded media segment, the user may execute a number of navigation commands by one or more gestures (e.g. swipes) or postures. For example: a HORIZONTAL LEFT gesture means—move to the previous segment of the same program; a HORIZONTAL RIGHT gesture means—move to the next segment of the same program; a VERTICAL UP gesture, means—move to related segment of a different program; a VERTICAL DOWN gesture means—move back to the previous related segment. At the following step, the selected navigation command is transmitted, for example from the user's device (e.g. mobile phone 41) to the server.

In some embodiments, the navigation gesture angle or speed may define the navigation action meaning in accordance with the program of the viewed segment. For example, for a media segment related to ‘politics’, a VERTICAL UP and LEFT gesture in respect to the user's vertical screen line means a navigation request for presenting a related segment which includes information on left political wing while for a media segment presenting a football game the VERTICAL UP and LEFT gesture means a navigation request for presenting a related segment which includes information on the left viewed football team. Accordingly, a VERTICAL UP and RIGHT gesture in respect to the user's vertical screen line means a navigation request presenting a related segment including information on the right political wing, and for football game media segment the VERTICAL UP and RIGHT gesture means requesting to present a related media segment on the team playing on the right.

Alternatively or in combination, as part of user navigation request of step 504, the user may navigate to a desired media segment by a “push and swipe” gesture operated on a specific image in a media segment. For example, the user may select a particular image of interest which is part of a video frame of the currently viewed segment, by placing his fingers on the particular image and then swipe to view a related segment which is linked by content or other criteria to the particular image. The media player saves information relating to the viewer's image selection. The information may include frame number and location of the pushed image.

At step 505, the media player software module updates the play session info on information relating to the last user's navigation request. At step 506, the media player software module sends the server the details of the user navigation request for the next segment. The details may include the play session info, which further includes the viewed segments and user navigation requests of the play session.

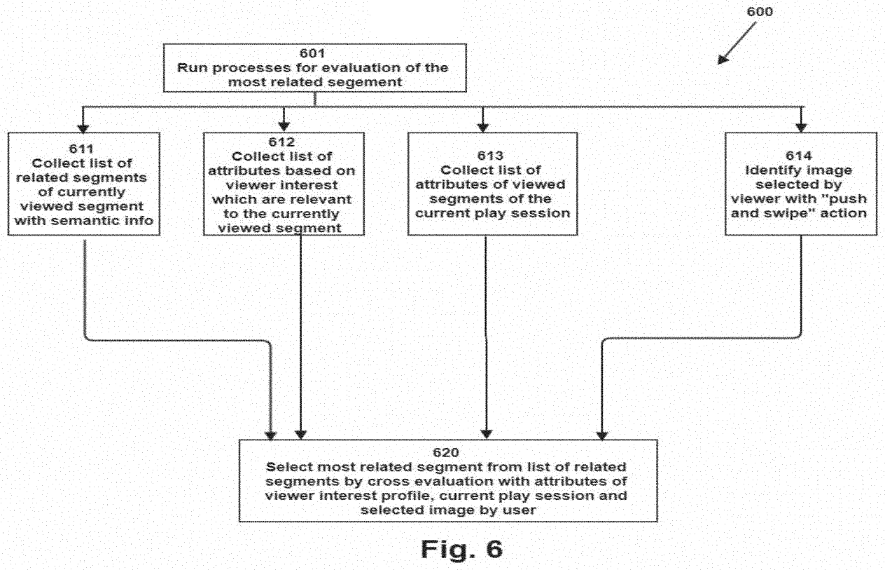

At step 507, the navigation command attached to the play session information is received for example by the server. Once received, the server updates viewer profile DB 23 with the updated play session info of the user and reads from the DB segment info 22, the media segment object info of the segment which is currently viewed by the user. The media segment info may include information on the currently viewed segment, for example segment semantic info or links to other segments with similar semantics. At step 509, the received navigation command is processed. For example the navigation command may be processed by the server as follows: if the user's navigation request is a horizontal navigation request, then at step 520 the server reads from the segment media object the next segment of the program. If the user navigation request is a vertical navigation request, then at step 510, the server checks if the vertical navigation request is vertical up navigation request or vertical down navigation request. If the user navigation request is a vertical up navigation request, then at step 515 the server evaluates the most related segment for the T17 currently viewed segment. The evaluation process of step 515 is described in further detail herein in respect to FIG. 6. If the user navigation request is a vertical down navigation request, then at step 516, the server reads from viewer profile DB 23, the play session info which contains the previous viewed related segment. At step 530 the server sends the client the next media segment to play. In some embodiments, at step 530 the server provides the client's URL for the next segment. The navigation process proceeds to step 502 for downloading and presenting the next media segment.

FIG. 6 shows a flowchart of a method 600 for selecting the most related segment out of a list of related segments, in accordance with embodiments. At step 601, the semantic segment management software module 17 or other module, initiates a number of processes for example simultaneously as described herein, to evaluate the most related media segment for the currently viewed segment. In accordance with embodiments, the media segment object of the currently viewed segment stored on the segment info DB 22, is prepared for the processes usage. Optionally or in combination, at step 611, a list of related segments for the currently viewed segment is set, for example based on the links to related segments info of similar semantic stored on the media segment object. For each media segment in the list, the attributes and features of the semantic characters of each related segment in the list is collected from the media segment object. Optionally or in combination, at step 612, a list of user personalized attributes and features which are relevant to the currently viewed segment is set, for example based on the viewer interest profile stored on DB of user profile 23. Optionally or in combination, at step 613, another list of personalized attributes and features is set, based on the semantic info of the segments viewed in the current play session. The play session info contains information relating to the user's viewed segments in the current play session and the semantic info for each viewed segment is extracted from the media segment object. Optionally or in combination, at step 614, the server identifies the image which the user selected by the “push and swipe” operation. The image identification method may be operated according to known search images tools. At step 620, the most related segment from the list of related segments is selected. The selection may be performed using decision making methods implemented by decision making software such as Muki-Attribute Global Inference of Quality (MAGIQ) methods. For example, for each of the steps 611-614 a related rank is measured according to the significance process results. In some cases, since step 614 is based on user feedback, it will gain a high rank according to the image that was selected by the user, while process 611 will gain a high rank according to the similarity level between related segments. In some cases, step 620 includes combining one or more of the steps 611-614 results, for example a cross evaluation of the attributes and features of the related segments defined in the list of related segments, with the attributes and features in the list of attributes of user interest profile, the list of attributes in the current play session and the image selected by user.

In further embodiments, the processing unit may be a digital processing device including one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the system disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device.

In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media. In some embodiments, the system disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBeryry App World, App Store for Palm devices, App Catalog for webOS, Windows® Marketplace for Mobile, Ovi Store for Nokia® devices, Samsung® Apps, and Nintendo® DSi Shop.

In some embodiments, the system disclosed herein includes software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the system disclosed herein includes one or more databases, or use of the same. In view of the disclosure provided herein, those of skill in the art will recognize that many databases are suitable for storage and retrieval of information as described herein. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A device comprising:
a display;
a user interface configured to receive a navigation command from a user;
a communication module configured to communicate with a server, said server comprising:
a segmentation module configured to download one or more media contents from one or more external sources and divide the downloaded media contents into a plurality of media segments based on semantic analysis;
a semantic segment management module configured to analyze each media segment of said plurality of media segments to yield a plurality of related media segments;
a processor configured to:
receive from said server said plurality of media segments;
present on said display one or more media segments of said plurality of media segments and in response to said navigation command present the most related segment of said plurality of related media segments on said display.

2. The device of claim 1 wherein said segmentation module is configured to analyze said one or more downloaded media contents and define a segment structure for each of said plurality of media segments.

3. The device of claim 2 wherein said segment structure is defined according to attributes or features of each of said plurality of media segments.

4. The device of claim 3 wherein said attributes are selected from the group consisting of:
well defined set of images; anchor images; camera angel or focus; audio energy or frequencies.

5. The device of claim 1 wherein said semantic segment management module is configured to analyze attributes or features of said plurality of media segments to yield semantic info.

6. The device of claim 5 wherein said sematic info comprises formal naming of attributes or features.

7. The device of claim 6 wherein said formal naming of attributes and features are topics or names of persons.

8. The device of claim 1 wherein said semantic segment management module is configured to generate a media segment object for each media segment of said plurality of media segments.

9. The device of claim 8 wherein said media segment object comprises: segment's borders; segment semantic data info; links between segments of similar semantics.

10. The device of claim 9 wherein the semantic data info comprises common meaning of features and attributes of the media content.

11. The device of claim 1 wherein said semantic analysis comprises measuring a semantic similarity between media segments of said plurality of media segments and interlinking said media segments.

12. The device of claim 11 wherein the semantic similarity between segments is measured according to topic or chronological order or media segment rating or contextual relation between media segments.

13. The device of claim 1 wherein said semantic segment management module is configured to convert the downloaded media contents to text for segmenting the converted media content to a plurality of media segments.

14. The device of claim 1 wherein said downloaded media content is segmented using machine learning techniques.

15. The device of claim 1 wherein said downloaded media content is segmented according to identified keywords or named entities on a text of said media content.

16. The device of claim 1 wherein said related media segments are of different media segments.

17. The device of claim 1 wherein said related media segments are of the same media segments.

18. The device of claim 1 wherein said navigation command is in the form of one or more gestures or swipes.

19. The device of claim 1 wherein the navigation command is selected from a group of navigation commands consisting of:
horizontal left gesture; horizontal right gesture; vertical left gesture; vertical down gesture;
vertical up and left gesture; vertical up and right gesture; vertical down and left gesture; vertical down and right gesture, push and swipe gesture.

20. The device of claim 1 wherein the user interface is configured to present one or more icons, said icons comprise links to recently viewed segments.

21. The device of claim 20 wherein said icons comprise one or more images of the viewed media segments.

22. The device of claim 1 wherein said related segments are identified according to the user navigation history.

23. The device of claim 1 wherein said related segments are identified according to the user previous “push and swipe” gestures.

24. The device of claim 1 comprising a video talk back application.

25. The device of claim 1 wherein the related segments are one or more user video recorded feedbacks of a media segment.

26. The device of claim 1 wherein said most related media segment is selected by cross evaluating one or more of the following lists:
list of related segments of currently viewed segments; list of attributes based on viewer interest;
list of attributes of viewed segments of the current play session; images selected by the viewer by ‘push and swipe’ action.

27. The device of claim 1 wherein a plurality of related feedbacks may be linked to one or more media segments of said plurality of media segments.

28. The device of claim 27 wherein each related feedback segment comprises a weight which may be defined according to the importance or relevance of the related feedback segment.

29. The device of claim 1 comprising one or more short cut navigations buttons for navigating back from one of said plurality of media segment to the first or previously viewed media segment.

30. A method for navigating between a plurality of media segments of one or more media contents, the method comprising:
displaying a media content on a display of a device having a processor, activating a segmentation module configured to divide the downloaded media content into a plurality of media segments and a semantic segment management module configured analyze each media segment of said plurality of media segments to yield a plurality of related media segments;
processing said navigation command at said processor, displaying related media segments according to said processed navigation command.

31. The method of claim 30 wherein said navigation command is a vertical navigation request and in response to said vertical navigation request the server checks if the vertical navigation request is vertical up navigation request or vertical down navigation request and if the user navigation request is a vertical up navigation request the server evaluates the most related segment for the currently viewed segment, if not, then the server reads the previous viewed related segment.

32. The method of claim 30 wherein said navigation command is a horizontal navigation command and the server reads from the segment media object the next segment of the program.

33. A method comprising:
downloading at least one media content from a server or any content source;
analyzing said at least one media content to identify a plurality of media segments at said at least one media content based on semantic analysis;
evaluating attributes or features for each of said plurality of media segments to yield semantic information for each media segment;
linking media segments which have semantic similarity;
displaying a media segment to a user, in response to a user navigation command presenting a most related media segment which is linked with the displayed media segment.

34. The method of claim 33 comprising selecting the most related media segment by cross evaluating one or more of the following lists:
list of related segments of currently viewed segments; list of attributes based on viewer interest; list of attributes of viewed segments of the current play session; images selected by the viewer by ‘push and swipe’ action.

35. A communication module configured to communicate with a server, said server comprising:
a segmentation module configured to download one or more media contents from one or more external sources and divide the downloaded media contents into a plurality of media segments based on based on semantic analysis;
a semantic segment management module configured to search one or more semantic similarities between said plurality of media segments to yield a plurality of related media segments;
a processor configured to:
receive from said server said plurality of media segments;
present on said display one or more media segments of said plurality of media segments and in response to said navigation command present the most related segment of said plurality of related media segments on said display.
